(19) United States
(12) Patent Application Publication
(10) Pub. No.: US 2013/0247645 A1
(43) Pub. Date: Sep. 26, 2013

(54) HARDNESS TESTER AND HARDNESS TESTING METHOD

(71) Applicants: Hiroshi Sakaiya, Akita-shi (JP); Kuniki Toshima, Akita-shi (JP)

(72) Inventors: Hiroshi Sakaiya, Akita-shi (JP); Kuniki Toshima, Akita-shi (JP)

(73) Assignee: MATSUZAWA CO., LTD., Akita-shi, Akita (JP)

(21) Appl. No.: 13/808,514

(22) PCT Filed: Mar. 26, 2012
(86) PCT No.: PCT/JP2012/057835

§ 371 Date: Jan. 4, 2013

(51) Int. Cl. G01N 3/44

(52) U.S. Cl. CPC G01N 3/44
USPC 73/1.89; 73/83

(57) ABSTRACT

[Problem] To provide a hardness tester capable of measuring hardness accurately without removing a surface layer and also provide a hardness testing method.

[Solution] An initial test load which is arbitrarily changed from a reference value is applied to the surface of a sample by an indenter 11, a major test load obtained by adding an additional test load to the initial test load is applied thereto, and the load is returned to the initial test load. The difference in depth of penetration of the indenter between the first and second two initial test loads is referenced to determine test hardness of the sample based on a Rockwell hardness computing equation. Correction is made for deviation of hardness from the thus determined test hardness due to a change in the initial test load from the reference value.

### TECHNICAL FIELD

The present invention relates to a hardness tester for assessing hardness of a sample by pressing an indenter into the surface of the sample and also to a hardness testing method.

### BACKGROUND ART

Rockwell hardness has been extensively used as a scale for indicating the hardness of a material. The Rockwell hardness is a value which is calculated from the difference in depth of penetration of an indenter between first and second two initial test loads, which are obtained when an initial test load is applied to a sample, and when a major test load obtained by adding an additional test load to the initial test load is applied to the sample and the load is returned to the initial test load. Japanese Industrial Standards have specified one initial test load of 10 kgf and three major test loads of 60 kgf, 100 kgf and 150 kgf. For the above-described Rockwell hardness test, there have been various proposals submitted for improving accuracy of the test. (For example, refer to Patent Document 1.)

### PRIOR ART DOCUMENT

### Patent Document

[Patent Document 1] Japanese Published Unexamined Patent Application No. 2000-105182

### SUMMARY OF THE INVENTION

### Problem to be Solved by the Invention

However, in Rockwell hardness, assessment is made by pressing an indenter from the surface of a sample. Therefore, where there is a thick layer such as an oxide film that is not a measurement target on the surface of the sample, as in case of hot-pressed special steel, it is impossible to make a correct assessment. Therefore, conventionally, the surface of the sample is scraped off to remove the oxide film or the like, by which the measurement target is exposed on the surface and, thereafter, a test is conducted. As a result, the additional time and effort required for pretreatment pose a problem.

The present invention has been carried out to solve the above problem, an object of which is to provide a hardness tester capable of measuring hardness accurately without removing a surface layer, and a hardness testing method.

### Means for Solving the Problem

The hardness tester of the present invention assesses hardness of a sample with reference to the difference in depth of penetration of an indenter between first and second two initial test loads, which are obtained when an initial test load is applied to the surface of the sample by the indenter, and when a major test load obtained by adding an additional test load to the initial test load is applied to the sample and the load is returned to the initial test load. The hardness tester is provided with a pressing means which presses the indenter into the surface of the sample by applying the load to the indenter, an initial test load setting means which makes it possible to set the initial test load applied to the surface of the sample by the indenter so as to be arbitrarily changed from a reference value, a depth detection means which detects depth of penetration of the indenter pressed into the surface of the sample by the pressing means, a hardness computing means which determines test hardness of the sample based on a Rockwell hardness computing equation with reference to the difference in depth of penetration of the indenter between the first and second two initial test loads detected by the depth detection means, and a correction means which corrects deviation of hardness from the test hardness determined by the hardness computing means due to a change in the initial test load from the reference value.

The hardness testing method of the present invention is a method for assessing hardness of a sample with reference to the difference in depth of penetration of an indenter between first and second two initial test loads, which are obtained when an initial test load is applied to the surface of the sample by the indenter, and when a major test load obtained by adding an additional test load to the initial test load is applied to the sample and the load is returned to the initial test load. In the hardness testing method, the initial test load applied to the surface of the sample by the indenter is set so as to be arbitrarily changed from a reference value, the difference in depth of penetration of the indenter between the first and second two initial test loads is referenced to determine test hardness of the sample based on the Rockwell hardness computing equation, and correction is made for deviation of hardness from the thus determined test hardness due to a change in the initial test load from the reference value.

### Effects of the Invention

According to the hardness tester and the hardness testing method in the present invention, the initial test load applied to the surface of a sample by the indenter can be set so as to be arbitrarily changed from a reference value. Therefore, even where there is a layer, such as an oxide film, that is not a measurement target on the surface of the sample, an increase in initial test load makes it possible to press the indenter down below a layer that is not the measurement target when the initial test load is applied. As a result, there is no need for such treatment as scraping off the surface of the sample, and the hardness can be easily measured. Further, correction is made for deviation of hardness from the determined test hardness due to a change in the initial test load from the reference value. It is, thereby, possible to determine the hardness of the sample accurately.

Further, an initial test load which is arbitrarily changed from a reference value is applied to several reference pieces for which the hardness is known. Then, a major test load obtained by adding an additional test load to the initial test load is applied thereto, and the load is returned to the initial test load. The difference in depth of penetration of the indenter between the first and second two initial test loads is referenced to determine test hardness of the reference piece based on a Rockwell hardness computing equation, and correction is made for the test hardness of the sample based on a relationship between the test hardness of the reference piece obtained on application of each initial test load and the known hardness of the reference piece. Thereby, it is possible to make an accurate correction.

### BRIEF DESCRIPTION OF THE DRAWINGS

FIG. 1 is a partial cross sectional view which shows a configuration of a hardness tester of one embodiment in the present invention.

FIG. 2 is a drawing which shows a relationship between test hardness of a reference piece and hardness of the reference piece.

FIG. 3 is a drawing which shows results of corrected values obtained in the present example.

### MODE FOR CARRYING OUT THE INVENTION

Hereinafter, a detailed description will be given of the embodiment of the present invention with reference to the drawings.

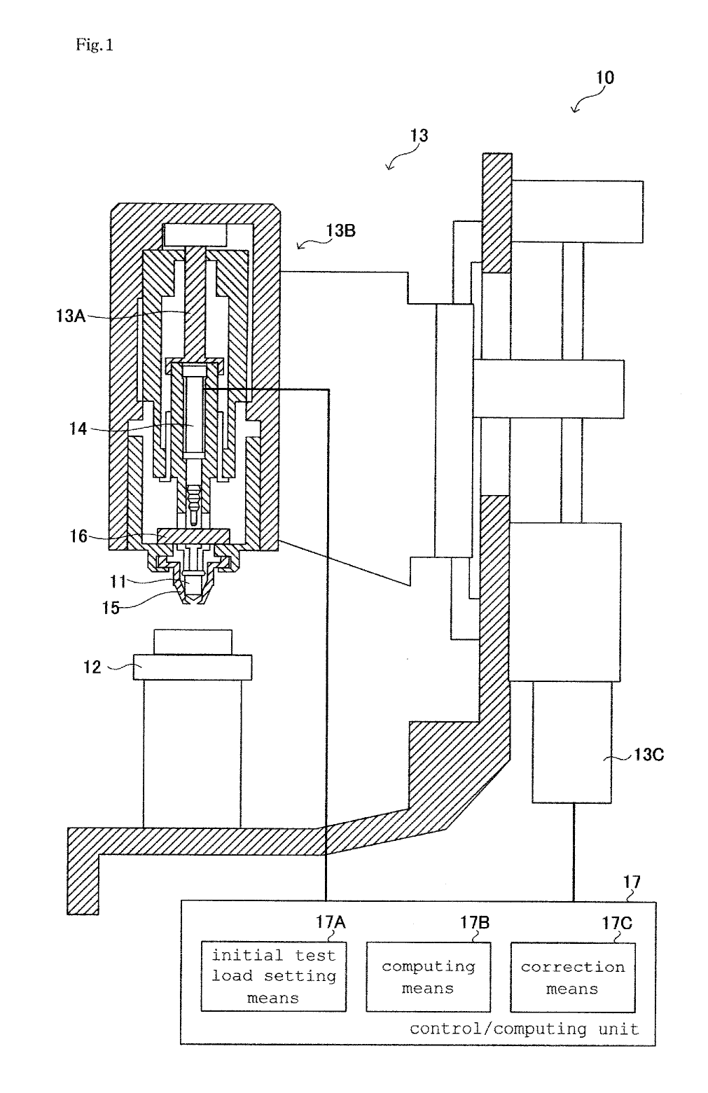

FIG. 1 is a drawing which shows a configuration of a hardness tester 10 of one embodiment in the present invention. The hardness tester 10 is to assess hardness of a sample with reference to the difference in depth of penetration of an indenter 11 between the first and second two initial test loads, which are obtained when an initial test load is applied to the surface of the sample by the indenter 11, and when a major test load obtained by adding an additional test load to the initial test load is applied to the sample and the load is returned to the initial test load. That is, this is a so-called Rockwell hardness tester.

The hardness tester 10 is provided with a sample base 12 on which, for example, a sample M, which is a measurement target, is placed. The indenter 11 which presses the surface of a sample is disposed over the sample base 12. The indenter 11 is configured so as to be pressed into the surface of the sample, with loads being applied, for example, by a pressing means 13. The pressing means 13 is provided, for example, with a load shaft 13A which is installed so as to extend above the indenter 11, a case 13B which supports the load shaft 13A and a motor 13C which allows the case 13B to move vertically.

Inside the load shaft 13A, there is disposed, for example, a depth detection means 14 for detecting the depth of penetration in which the indenter 11 is pressed into the surface of a sample by the pressing means 13. The depth detection means 14 is configured, for example, with a digital gauge and disposed coaxially with the indenter 11. Around the indenter 11, there is disposed, for example, a hollow contactor 15 so as to be vertically movable with respect to the case 13B. The contactor 15 is to hold down the sample M and also detect a position on the surface of the sample. The contactor 15 is provided with a detecting body 16 with which, for example, the tip of the depth detection means 14 is in contact.

Further, the hardness tester 10 is provided, for example, with a control/computing unit 17 which controls the hardness tester 10 and makes computation. The control/computing unit 17 is provided, for example, with an initial test load setting means 17A which makes it possible to set an initial test load applied to the surface of a sample by the indenter 11 so as to be arbitrarily changed from a reference value, and a hardness computing means 17B which determines test hardness of the sample M based on a Rockwell hardness computing equation with reference to the difference in depth of penetration of the indenter 11 between the first and second two initial test loads detected by the depth detection means 14.

The reference value of the initial test load is 10 kgf. The initial test load setting means 17A is to set a value of the initial test load which is different from 10 kgf of the reference value, thereby controlling a pressed amount of the indenter 11 by the pressing means 13. The Rockwell hardness computing equation used in computation by the hardness computing means 17B is, for example, HR=a−b×h, wherein HR is Rockwell hardness, a and b are values determined for each scale, and h is the difference in depth of penetration of the indenter 11 between the first and second two initial test loads. For example, a is 100 or 130 and b is 500.

The control/computing unit 17 is also provided with a correction means 17C which corrects deviation of hardness from test hardness determined by the hardness computing means 17B due to a change in an initial test load from a reference value. It is preferable that the correction means 17C is configured in such a manner that, for example, an initial test load which is arbitrarily changed from a reference value is applied to several reference pieces for which the hardness is known, and then a major test load obtained by adding an additional test load to the initial test load is applied and the load is returned to the initial test load. The difference in depth of penetration of the indenter between the first and second two initial test loads is referenced to determine test hardness of the reference piece based on the Rockwell hardness computing equation, and correction is made for the test hardness of a sample based on a relationship between the test hardness of the reference piece obtained on application of each initial test load and the known hardness of the reference piece.

It is preferable that the initial test load is changed, for example, from 15 kgf, 20 kgf, 25 kgf, 30 kgf, 35 kgf to 40 kgf, the difference in depth of penetration of the indenter between the first and second two initial test loads is referenced to determine test hardness of a reference piece, and a relational expression between the test hardness of the reference piece obtained on application of each initial test load and the known hardness of the reference piece is determined, thereby correcting the test hardness based on the relational expression.

In the hardness testing method of the present embodiment, the hardness tester 10 is used to measure the hardness, for example, by the following manner. First, for example, the initial test load setting means 17A is used to set an initial test load so as to be arbitrarily changed from a reference value. Then, for example, a sample M is placed on the sample base 12, the motor 13C is driven to allow the case 13B to move downward, by which the contactor 15 is brought into contact with the surface of the sample. Thereafter, the motor 13C is driven, by which the case 13B is allowed to move downward. The load shaft 13A is used to press the indenter 11, and the initial test load is applied to the surface of the sample by the indenter 11. At this time, the depth detection means 14 is used to detect the depth of penetration of the indenter 11 which has been pressed into the surface of the sample.

Then, the motor 13C is driven, by which the case 13B is allowed to move downward. The load shaft 13A is used to press the indenter 11, a major test load obtained by adding an additional test load to the initial test load is applied to the surface of the sample by the indenter 11. Thereafter, the motor 13C is driven, by which the case 13B is allowed to move upward, and the load applied to the surface of the sample by the indenter 11 is returned to the initial test load. At this time, the depth detection means 14 is used to detect the depth of penetration of the indenter 11, which has been pressed into the surface of the sample. It is noted that the major test load is determined by a scale and can be arbitrarily set.

Then, the difference in depth of penetration of the indenter between the first and second two initial test loads is referenced to determine the test hardness of the sample M based on the Rockwell hardness computing equation, and correction is made for deviation of hardness from the thus determined test hardness due to a change in the initial test load from the reference value. An initial test load which is changed from a reference value is applied to several reference pieces for which the hardness is known to determine test hardness of the reference piece, as with the test hardness of the sample M. Correction is made based on a relationship between the test hardness of the reference piece obtained on application of each initial test load and the known hardness of the reference piece. Thereby, the hardness of the sample M can be determined.

According to the above-described present embodiment, an initial test load applied to the surface of the sample by the indenter 11 can be set so as to be arbitrarily changed from a reference value. Therefore, even where there is a layer, such as an oxide film, that is not a measurement target on the surface of the sample, an increase in initial test load makes it possible to press the indenter 11 down below a layer that is not the measurement target when the initial test load is applied. As a result, there is no need for treatment such as scraping off the surface of the sample and the hardness can be easily measured. Further, correction is made for deviation of hardness from the determined test hardness due to a change in the initial test load from the reference value. It is, thereby, possible to determine the hardness of the sample M accurately.

Still further, an initial test load which is changed from a reference value is applied to several reference pieces for which the hardness is known, and the test hardness of the reference piece is determined, as with the sample M. Correction is made for the test hardness of the sample M based on a relationship between the test hardness of the reference piece obtained on application of each initial test load and the known hardness of the reference piece. Thereby, it is possible to make an accurate correction.

### Example

An initial test load which was changed from a reference value was applied to several reference pieces for which the hardness is known, and the above-described hardness tester 10 was used to determine the test hardness of the reference piece. More specifically, the initial test load was applied to the reference piece, a major test load obtained by adding an additional test load to the initial test load was applied thereto, and the load was returned to the initial test load. The difference in depth of penetration of the indenter between the first and second two initial test loads was referenced to determine the test hardness of the reference piece based on a Rockwell hardness computing equation.

Reference pieces were tested with regard to ten kinds of Rockwell hardness, that is, HRC 20, HRC 25, HRC 30, HRC 35, HRC 40, HRC 45, HRC 50, HRC 55, HRC 60 and HRC 65. The initial test load was increased by 5 kgf starting from 10 kg of the reference value, that is, from 15 kgf, 20 kgf, 25 kgf, 30 kgf, 35 kgf to 40 kgf, and the hardness of the reference piece was determined for each of load. The major test load was 150 kgf, and the Rockwell hardness computing equation was HRC=100-500 h. It is noted that HRC stands for hardness of Rockwell C scale, in which h is the difference in depth of penetration of the indenter between the first and second two initial test loads. The test hardness of the reference piece was obtained by measuring the hardness of one reference piece at five sites to determine a mean value thereof. Table 1 shows the thus obtained test hardness of the reference pieces.

TABLE 1

| | test hardness of a reference piece | | | | | |
|---|---|---|---|---|---|---|
| | initial test | initial test | initial test | initial test | initial test | initial test |
| | load 15 kgf | load 20 kgf | load 25 kgf | load 30 kgf | load 35 kgf | load 40 kgf |
| HRC20 | 26.75 | 32.38 | 37.27 | 41.91 | 45.33 | 49.30 |
| HRC25 | 30.45 | 35.67 | 39.74 | 45.37 | 48.60 | 51.55 |
| HRC30 | 35.63 | 40.69 | 45.17 | 49.25 | 52.65 | 55.50 |
| HRC35 | 40.56 | 44.71 | 48.87 | 52.93 | 55.41 | 58.19 |
| HRC40 | 44.61 | 48.86 | 52.09 | 56.18 | 58.22 | 61.28 |
| HRC45 | 49.15 | 53.31 | 57.25 | 60.01 | 62.06 | 64.41 |
| HRC50 | 53.77 | 57.57 | 61.25 | 63.43 | 65.87 | 67.28 |
| HRC55 | 58.58 | 62.24 | 64.63 | 66.97 | 69.02 | 70.85 |
| HRC60 | 62.73 | 66.26 | 68.68 | 70.26 | 72.27 | 73.69 |
| HRC65 | 66.34 | 69.08 | 71.76 | 73.04 | 74.97 | 76.48 |

TABLE 2

| | initial test load | | | | | |
|---|---|---|---|---|---|---|
| | 15 kgf | 20 kgf | 25 kgf | 30 kgf | 35 kgf | 40 kgf |
| test | 48.60 | 52.49 | 56.14 | 59.95 | 61.97 | 64.51 |
| hardness | | | | | | |
| corrected | 44.29 | 44.14 | 44.39 | 45.34 | 45.04 | 45.21 |
| values | | | | | | |

### [Table 1]

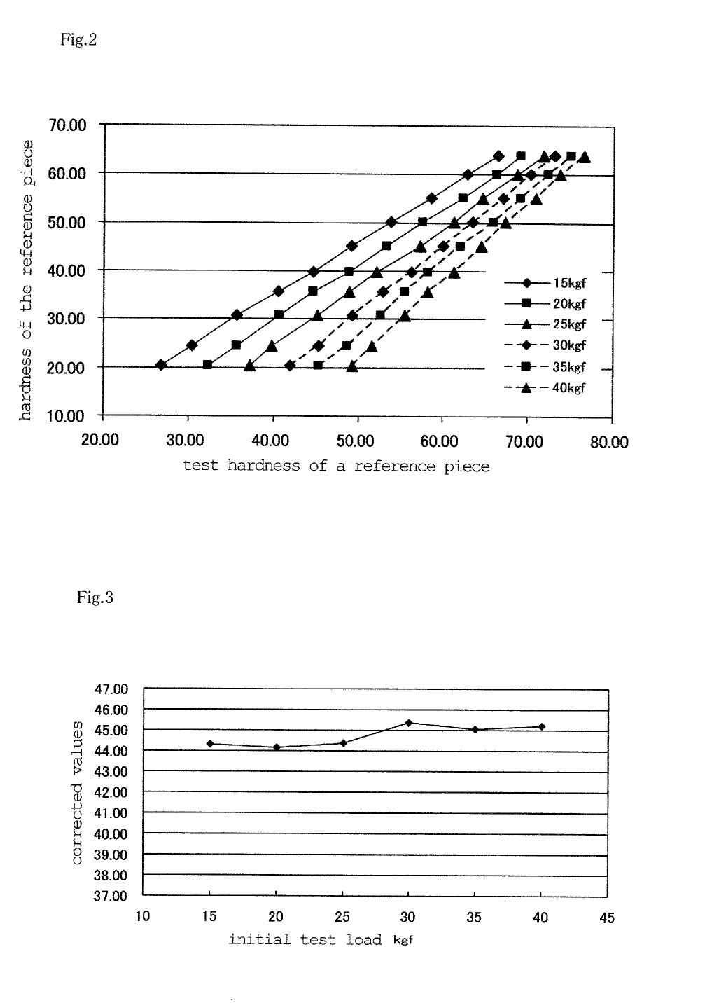

Then, the test hardness of the reference pieces obtained on application of each initial test load and the hardness of the reference pieces for which the hardness is known were shown in a graph. FIG. 2 shows the thus obtained results. As shown in FIG. 2, there was found such a tendency that the plastic deformation amount was decreased and hardness value was increased with an increase in initial test load.

Then, hot-pressed special steel was prepared as a sample M, and the above-described hardness tester 10 was used to determine the test hardness by changing an initial test load. More specifically, the initial test load was applied to the sample M, a major test load obtained by adding an additional test load to the initial test load was applied thereto, and the load was returned to the initial test load. The difference in depth of penetration of the indenter between the first and second two initial test loads was referenced to determine the test hardness based on the Rockwell hardness computing equation.

The initial test load was changed from 15 kgf, 20 kgf, 25 kgf, 30 kgf, 35 kgf to 40 kgf, and test hardness was determined for each of load. The major test load was set to be 150 kgf and the Rockwell hardness computing equation was given as HRC=100-500 h, in which HRC and h were as described above. The test hardness was determined for one sample M at 5 sites, from which a mean value was obtained.

Then, the thus obtained test hardness values were corrected with reference to a relationship between the test hardness of a reference piece determined by using the reference piece and the known hardness of the reference piece. The thus obtained results are shown in Table 2 and FIG. 3.

### [Table 2]

Further, comparative examples of the present example were prepared. One was sample M with its surface polished to remove an oxide film, and another was sample M with its surface not polished and oxide film intact. Then, an initial test load was set to be 10 kgf, which is a reference value, and test hardness was determined, with other procedures conducted similarly as with the present example. No correction was made. As a result, the sample M with the polished surface exhibited a test hardness of 44.90, while the sample M with the unpolished surface exhibited a test hardness of 38.0.

In contrast, according to the present example, a hardness value was obtained by correction was in the range from 44.14 to 45.34, exhibiting results similar to those obtained for the sample with the polished surface. That is, it was found that the present example was able to easily measure the hardness at a high accuracy.

A description has been so far given of the present invention with reference to the embodiment, to which the present invention shall not be limited. Moreover, the present invention can be modified in various ways. For example, in the above-described embodiment, a description has been specifically given of a configuration of the hardness tester, but the present invention may have another configuration.

### INDUSTRIAL APPLICABILITY

The present invention can be used in a hardness test.

### DESCRIPTION OF REFERENCE NUMERALS

10 . . . hardness tester, 11 . . . indenter, 12 . . . sample base 13 . . . pressing means, 13A . . . load shaft, 13B . . . case, 13C . . . motor, 14 . . . depth detection means 15 . . . contactor, 16 . . . detecting body, 17 . . . control/computing unit, 17A . . . initial test load setting means, 17B . . . computing means, 17C . . . correction means

1. A hardness tester which assesses hardness of a sample with reference to the difference in depth of penetration of an indenter between first and second two initial test loads, which are obtained when an initial test load is applied to the surface of the sample by the indenter, and when a major test load obtained by adding an additional test load to the initial test load is applied to the sample and the load is returned to the initial test load,
the hardness tester comprising:
a pressing means which presses the indenter into the surface of the sample by applying the load to the indenter;
an initial test load setting means which makes it possible to set the initial test load applied to the surface of the sample by the indenter so as to be arbitrarily changed from a reference value;
a depth detection means which detects depth of penetration of the indenter pressed into the surface of the sample by the pressing means;
a hardness computing means which determines test hardness of the sample based on a Rockwell hardness computing equation with reference to the difference in depth of penetration of the indenter between the first and second two initial test loads detected by the depth detection means; and
a correction means which corrects deviation of hardness from the test hardness determined by the hardness computing means due to a change in the initial test load from the reference value.

2. The hardness tester according to claim 1, wherein
in the correction means, the initial test load which is arbitrarily changed from the reference value is applied to several reference pieces for which the hardness is known, then, a major test load obtained by adding an additional test load to the initial test load is applied thereto, and the load is returned to the initial test load. The difference in depth of penetration of the indenter between the first and second two initial test loads is referenced to determine test hardness of the reference piece based on the Rockwell hardness computing equation, and correction is made for the test hardness of the sample based on a relationship between the test hardness of the reference piece obtained on application of each initial test load and the known hardness of the reference piece.

3. A hardness testing method for assessing hardness of a sample with reference to the difference in depth of penetration of an indenter between first and second two initial test loads, which are obtained when an initial test load is applied to the surface of the sample by the indenter and when a major test load obtained by adding an additional test load to the initial test load is applied to the sample and the load is returned to the initial test load,
the hardness testing method, wherein
the initial test load applied to the surface of the sample by the indenter is set so as to be arbitrarily changed from a reference value, the difference in depth of penetration of the indenter between the first and second two initial test loads is referenced to determine test hardness of the sample based on a Rockwell hardness computing equation, and correction is made for deviation of hardness from the thus determined test hardness due to a change in the initial test load from the reference value.

4. The hardness testing method according to claim 3, wherein
the initial test load which is arbitrarily changed from the reference value is applied to several reference pieces for which the hardness is known, the major test load obtained by adding an additional test load to the initial test load is applied thereto, and the load is returned to the initial test load. The difference in depth of penetration of the indenter between the first and second two initial test loads is referenced to determine test hardness of the reference piece based on the Rockwell hardness computing equation, and correction is made based on a relationship between the test hardness of the reference piece obtained on application of each initial test load and the known hardness of the reference piece.
